(19) United States
(12) Patent Application Publication
(10) Pub. No.: US 2015/0227265 A1
(43) Pub. Date: Aug. 13, 2015

(54) GENERATING AND IMPLEMENTING A CUSTOMIZABLE USER INTERFACE

(71) Applicant: Packsize LLC, Salt Lake City, UT (US)

(72) Inventor: Andreas Harnesk, Sandy, UT (US)

(21) Appl. No.: 14/613,095

(22) Filed: Feb. 3, 2015

Related U.S. Application Data
(60) Provisional application No. 61/938,025, filed on Feb. 10, 2014.

(51) Int. Cl. G06F 3/0481; G06F 3/0484; H04L 29/08

(52) U.S. Cl. CPC G06F 3/0481; H04L 67/10; G06F 3/04842

(57) ABSTRACT

Embodiments are directed to generating a customizable user interface, to implementing predefined gadgets within a user interface and to providing hierarchical spaces within a user interface. In one scenario, a computer system receives a first input from the user indicating that a space is to be created within a user interface (UI), where each space is an area that holds gadgets, and where each gadget is a UI control. The computer system creates a space within the UI that provides context for those gadgets that are added to the space, where the context indicates rules or settings that are to be applied to those gadgets that are added to the space. The computer system also receives a second input from the user indicating that a gadget is to be added to the created space. The computer system then adds at least one gadget to the created space.

### CROSS-REFERENCE TO RELATED APPLICATIONS

This application claims priority to and the benefit of U.S. Provisional Patent Application No. 61/938,025, filed on Feb. 10, 2014, entitled “Generating and Implementing a Customizable User Interface,” which application is incorporated by reference herein in its entirety.

### BRIEF SUMMARY

Embodiments described herein are directed to generating a customizable user interface, to implementing predefined gadgets within a user interface and to providing hierarchical spaces within a user interface. In one embodiment, a computer system receives a first input from the user indicating that a space is to be created within a user interface (UI), where each space is an area that holds gadgets, and where each gadget is a UI control. The computer system then creates a space within the UI, where the space provides context for those gadgets that are added to the space, the context indicating rules or settings that are to be applied to those gadgets that are added to the space. The computer system also receives a second input from the user indicating that at least one gadget is to be added to the created space, and upon receiving the second input, the computer system adds at least one gadget to the created space, where the context-based rules or settings are applied to the gadgets in the created space. Allowing creation of such a customizable user interface ensures improved user efficiency when interacting with the UI. Indeed, a customizable UI that allows users to create spaces and gadgets reduces the mental effort involved as users can quickly and easily view what is important to them.

In another embodiment, a computer system implements predefined gadgets within a user interface. The computer system determines that a space has been created for a user interface (UI), where the space provides context for those predefined gadgets, user-defined gadgets and spaces that are added to the space. The computer system determines that the created space has been stored as a data structure in a data store along with predefined gadgets or user-defined gadgets, where the stored space and gadget together comprise a user-defined gadget. The computer system then accesses the user-defined gadget for implementation in the UI. The user-defined gadget is a user-oriented, foundational gadget for creating customizable user interfaces. The computer system also implements the user-defined gadget in one or more spaces of the UI, where the accessed space provides a set of functionality as a gadget. The user-defined gadget may define a minimized and a maximized view, where the minimized view is a subset of the maximized view. Implementation of predefined gadgets within a UI increases user interaction performance in that users can apply sets of gadgets to create highly-personalized, efficient user interfaces that only include the elements that are important to the user, while removing or omitting those that are not.

In yet another embodiment, a computer system determines that a first space has been created for a user interface (UI), where the first space provides context for those gadgets that are added to the first space. The computer system receives an input from a user indicating that a second user-defined gadget is to be created within the first space and creates a user-defined gadget within the first space. The user-defined gadget is a minimized user-defined gadget, so that the first space and the user-defined gadget form a hierarchy in the UI. The computer system further receives an input indicating that the UI is to be zoomed in to the minimized space and zooms in through the hierarchy of user-defined gadget to the minimized user-defined gadget within the UI.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates a computer architecture in which embodiments described herein may operate including generating a customizable user interface.

FIG. 2 illustrates a flowchart of an example method for generating a customizable user interface.

FIG. 3 illustrates a flowchart of an example method for implementing predefined gadgets within a user interface.

FIG. 4 illustrates a flowchart of an example method for providing hierarchical spaces within a user interface.

FIG. 5 illustrates an embodiment in which two different views of the same gadget are shown.

FIG. 6 illustrates an embodiment in which gadgets that occupy the same area generate a tabbed control.

FIG. 7 illustrates four different minimized views of the same space.

FIG. 8 illustrates an embodiment of an application that has four gadgets and one space.

FIG. 9 illustrates an alternative embodiment of an application that has four gadgets and one space.

FIG. 10 illustrates an application home view for a machine operator.

FIG. 11 illustrates an application view for advanced users.

FIG. 12 illustrates an application home space for an operator.

FIG. 13 illustrates an alternative view of a job queue gadget.

FIGS. 14A & 14B illustrate an embodiment in which spaces are added to an original space, and views are minimized or maximized within the added spaces.

FIGS. 15A-15C illustrate alternative embodiments in which spaces are added to an original space, and views are minimized or maximized within the added spaces.

### DETAILED DESCRIPTION

Embodiments described herein are directed to generating a customizable user interface, to implementing predefined gadgets within a user interface and to providing hierarchical spaces within a user interface. In one embodiment, a computer system receives a first input from the user indicating that a space is to be created within a user interface (UI), where each space is an area that holds gadgets, and where each gadget is a UI control. The computer system then creates a space within the UI, where the space provides context for those gadgets that are added to the space, the context indicating rules or settings that are to be applied to those gadgets that are added to the space. The computer system also receives a second input from the user indicating that at least one gadget is to be added to the created space, and upon receiving the second input, the computer system adds at least one gadget to the created space, where the context-based rules or settings are applied to the gadgets in the created space. Allowing creation of such a customizable user interface ensures improved user efficiency when interacting with the UI. Indeed, a customizable UI that allows users to create spaces and gadgets reduces the mental effort involved as users can quickly and easily view what is important to them.

In another embodiment, a computer system implements predefined gadgets within a user interface. The computer system determines that a space has been created for a user interface (UI), where the space provides context for those predefined gadgets, user-defined gadgets and spaces that are added to the space. The computer system determines that the created space has been stored as a data structure in a data store along with predefined gadgets or user-defined gadgets, where the stored space and gadget together comprise a user-defined gadget. The computer system then accesses the user-defined gadget for implementation in the UI. The user-defined gadget is a user-oriented, foundational gadget for creating customizable user interfaces. The computer system also implements the user-defined gadget in one or more spaces of the UI, where the accessed space provides a set of functionality as a gadget. The user-defined gadget may define a minimized and a maximized view, where the minimized view is a subset of the maximized view. Implementation of predefined gadgets within a UI increases user interaction performance in that users can apply sets of gadgets to create highly-personalized, efficient user interfaces that only include the elements that are important to the user, while removing or omitting those that are not.

In yet another embodiment, a computer system determines that a first space has been created for a user interface (UI), where the first space provides context for those gadgets that are added to the first space. The computer system receives an input from a user indicating that a second user-defined gadget is to be created within the first space and creates a user-defined gadget within the first space. The user-defined gadget is a minimized user-defined gadget, so that the first space and the user-defined gadget form a hierarchy in the UI. The computer system further receives an input indicating that the UI is to be zoomed in to the minimized space and zooms in through the hierarchy of user-defined gadget to the minimized user-defined gadget within the UI.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments described herein may implement various types of computing systems. These computing systems are now increasingly taking a wide variety of forms. Computing systems may, for example, be handheld devices such as smartphones or feature phones, appliances, laptop computers, wearable devices, desktop computers, mainframes, distributed computing systems, or even devices that have not conventionally been considered a computing system. In this description and in the claims, the term “computing system” is defined broadly as including any device or system (or combination thereof) that includes at least one physical and tangible hardware processor, and a physical and tangible hardware or firmware memory capable of having thereon computer-executable instructions that may be executed by the processor. A computing system may be distributed over a network environment and may include multiple constituent computing systems.

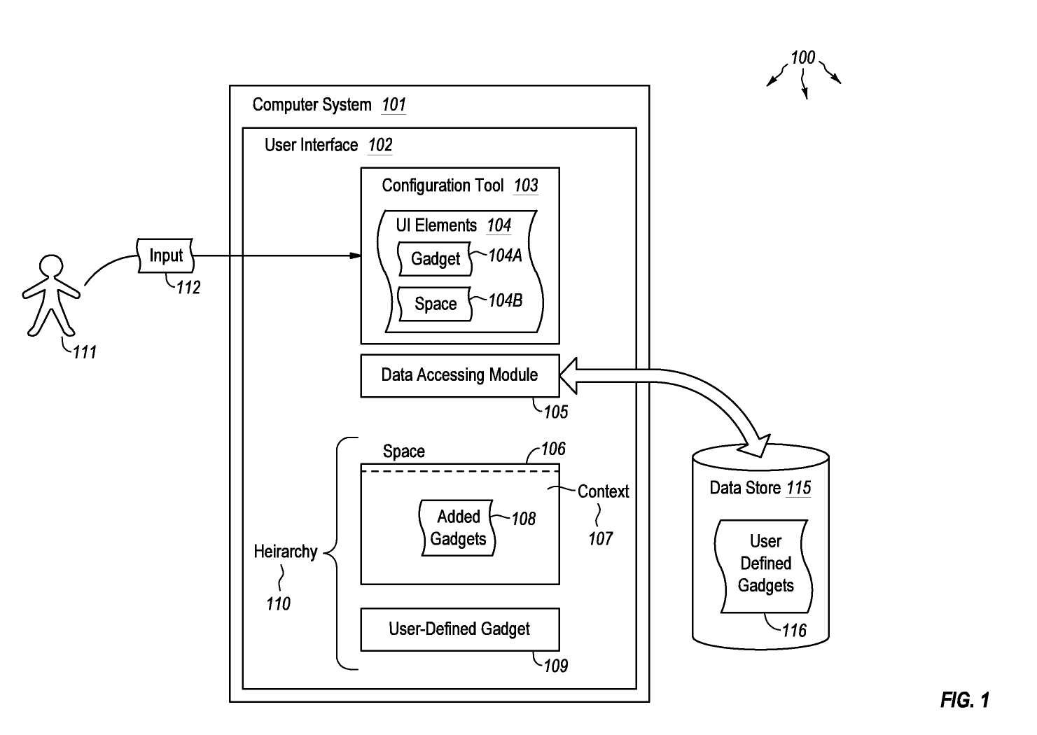

As illustrated in FIG. 1, a computing system 101 typically includes at least one processing unit 102 and memory 103. The memory 103 may be physical system memory, which may be volatile, non-volatile, or some combination of the two. The term “memory” may also be used herein to refer to non-volatile mass storage such as physical storage media or physical storage devices. If the computing system is distributed, the processing, memory and/or storage capability may be distributed as well.

As used herein, the term “executable module” or “executable component” can refer to software objects, routines, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media or computer-readable hardware storage devices that form a computer program product. An example of such an operation involves the manipulation of data. The computer-executable instructions (and the manipulated data) may be stored in the memory 103 of the computing system 101. Computing system 101 may also contain communication channels that allow the computing system 101 to communicate with other message processors over a wired or wireless network.

Embodiments described herein may comprise or utilize a special-purpose or general-purpose computer system that includes computer hardware, such as, for example, one or more processors and system memory, as discussed in greater detail below. The system memory may be included within the overall memory 103. The system memory may also be referred to as “main memory”, and includes memory locations that are addressable by the at least one processing unit 102 over a memory bus in which case the address location is asserted on the memory bus itself. System memory has been traditionally volatile, but the principles described herein also apply in circumstances in which the system memory is partially, or even fully, non-volatile.

Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media or storage devices that store computer-executable instructions and/or data structures are computer storage media or computer storage devices. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the principles described herein may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

FIG. 1 illustrates a computer architecture 100 in which at least one embodiment may be employed. Computer architecture 100 includes computer system 101. Computer system 101 may be any type of local or distributed computer system, including a cloud computing system. The computer system includes various modules for performing a variety of different functions. For instance, the data accessing module 105 may be configured to access data stored in data store 115. The data store 115 may be internal or external to computer system 101, and may include any type of local or distributed storage system (including network or cloud storage). The data accessed by the data accessing module 105 may be used as part of user interface (UI) 102.

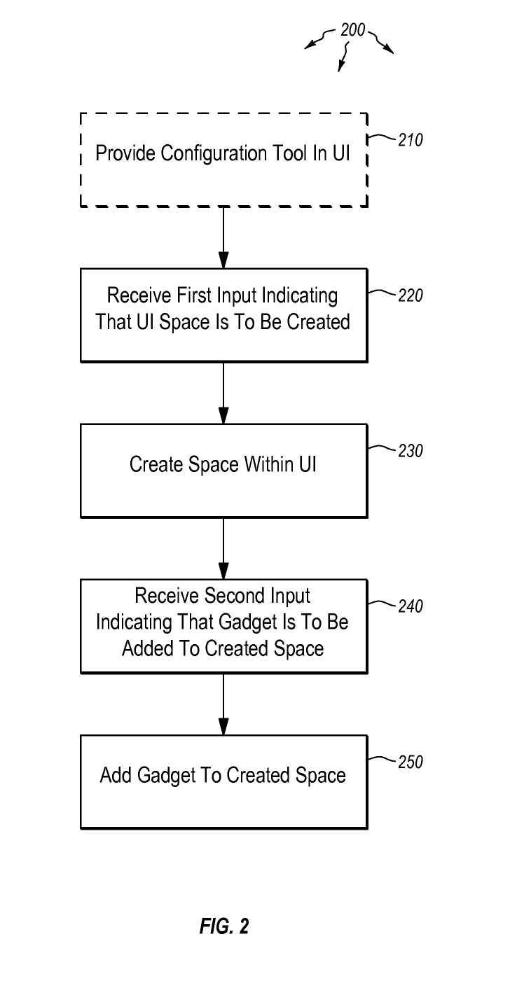

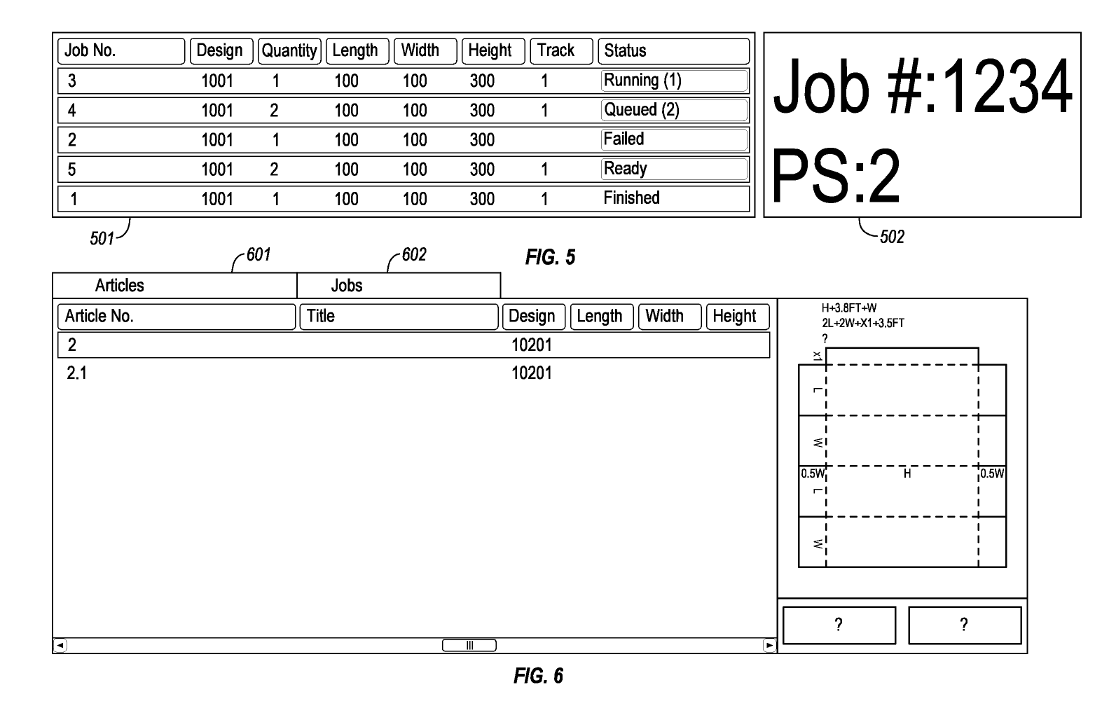

The UI includes configuration tools 103. These configuration tools may include, but are not limited to, UI elements 104 such as gadgets 104A and spaces 104B. A “gadget”, as the term is used herein, refers to a user interface control (such as button, a slider bar, a drop-down menu, lists (such as article lists, order lists, job lists, etc.), views (such as a packaging preview) or other type of UI control). When the term “gadget” is used herein, it may refer to user-defined gadgets and/or predefined gadgets, as will be explained further below. A “space”, as the term is used herein, refers to an area of the UI that holds one or more gadgets or other spaces. Thus, a space 106 may, for example, one or more added gadgets 108. The space provides context 107 for those gadgets that are within the space. Any gadget that is later added to that space receives or inherits the context of that space (this will be explained further below). Spaces may be maximized or minimized when stored as user-defined gadgets (e.g. 116). User-defined gadgets may be created by any type of user including end-users, administrators, IT managers, etc., and may be created using a combination of existing gadgets including user-defined and/or predefined gadgets. Each of these concepts will be described further below with regard to FIGS. 5-13, as well as methods 200, 300 and 400 of FIGS. 2, 3 and 4, respectively.

Each gadget can have a number of different views defined. When configuring a determined space, the user (e.g. 111) can select which view to use for each gadget using input 112. As each gadget can have multiple views, the gadgets can be displayed in a number of different ways. For example, for list gadgets, the columns displayed in the list can also be configured to extend the customization even more. As shown in FIG. 5, two images can display two different views of the same gadget. The view on the left (501) represents a view of a job queue gadget (in some embodiments, this is the default view). This view shows the jobs that are currently in the job queue. The view on the right (502) represents a “last completed job” view of the same gadget (i.e. the job queue gadget). To further expand the customization of the system described herein, list views may have a user-selectable display of columns. In some cases, users may not be as concerned about some elements of a job (such as the length, width and height of the job), but may be more interested in the manufacturing station for the job (e.g. a pack station). This may be configured in the settings of the gadget. As such, users can create a variety of different views for the same gadget (e.g. a job queue gadget), depending on their interest in the gadget

When a new space is created in the configuration tool 103, the user can then add gadgets to the space 106. The user may add (or remove) substantially any number of gadgets to any one space. To get something similar to a machine operator panel, a user 111 might select an article list gadget (e.g. using tab 601), a job list gadget (e.g. using tab 602), a preview gadget and/or a packaging command gadget, as shown in FIG. 6. Gadgets occupying the same area will generate a tabbed control (article, order, job list of FIG. 6). Thus, by adding an article list gadget, a job list gadget, a preview gadget and a packaging command gadget to a space, a user create an overall experience similar to a machine operator panel. This machine operator panel is different, however, in that each of the views may be removed or changed as desired by the user, while the other views stay as they are.

At least in some embodiments, gadgets may inherit their context from the current context of the space the gadgets is used in. Thus, as shown in FIG. 1, added gadgets 108 get their context 107 from space 106. The context may include certain settings, entity information, behavior characteristics or other features that are automatically applied to gadgets created in that space. Context for the space may be set either by configuration or from context selection gadgets. A space can hold multiple different contexts of different types. For example, a space could have a machine context and a packaging context. If a space has multiple context selection gadgets of the same type, then the last selection will clear the selection from the gadgets of the same type. In some embodiments, the article, order and job list each set the packaging (or other) context for the space. The packaging preview, job commands and details view all use the current packaging context of the space. In such cases, the article's context may be configured while the packaging context used by the preview and command context is set from the article list gadget.

As mentioned above, spaces may be configured using gadgets. The spaces can be stored and used in other projects as gadgets themselves (e.g. user-defined gadgets 116). When adding user-defined gadgets to another space, a minimized view of the added space will be shown. The minimized view of a space gives the user an overview of that space but still allows user interaction directly. At least in some embodiments, in newly created spaces, the minimized views are scaled views of the entire space. The user 111 may be able to configure several minimized views for each space. Configuring a minimized view for a space is done in the same way as the configuration of the space itself is done. By simply adding controls to an empty space, only controls from inside the space are available to add to the minimized space. Once a space is configured it can be stored and used in any other project.

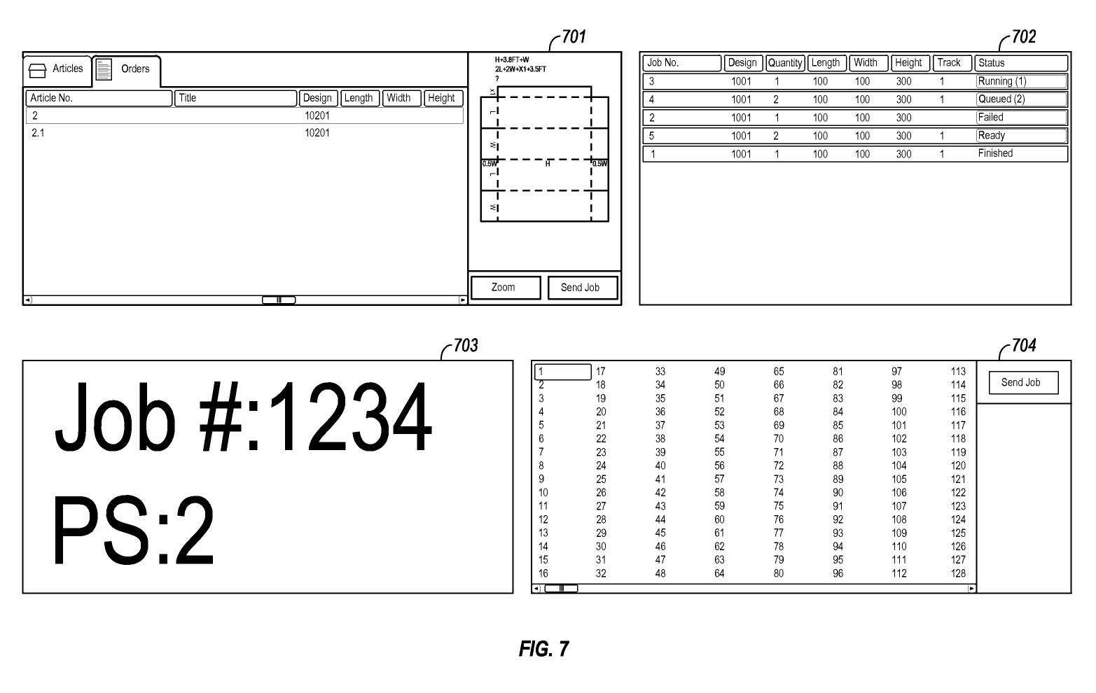

Four different minimized views of the same space are shown in FIG. 7. The top left view (701) is a scaled view of the entire space. The top right view (702) is a customized minimized space, showing a job queue gadget with its standard view. The view in the bottom left corner (703) has the same gadget in its minimized view, but shows another view of the job queue (i.e. the last finished job view). The view on the bottom right (704) shows a minimized space with an article list docked in the left side (set up to show the list view) and the packaging command gadget to the right.

Once the spaces are set up, they will form a hierarchy (e.g. hierarchy 110 of FIG. 1). The hierarchy allows the user 111 to zoom in to a minimized space for more detailed information. The operator can then move back to the space above by zooming out. The zoom in and zoom out inputs (e.g. 106) can be performed using a mouse wheel, a finger pinch inputs (when using a touch screen display) or other types of inputs.

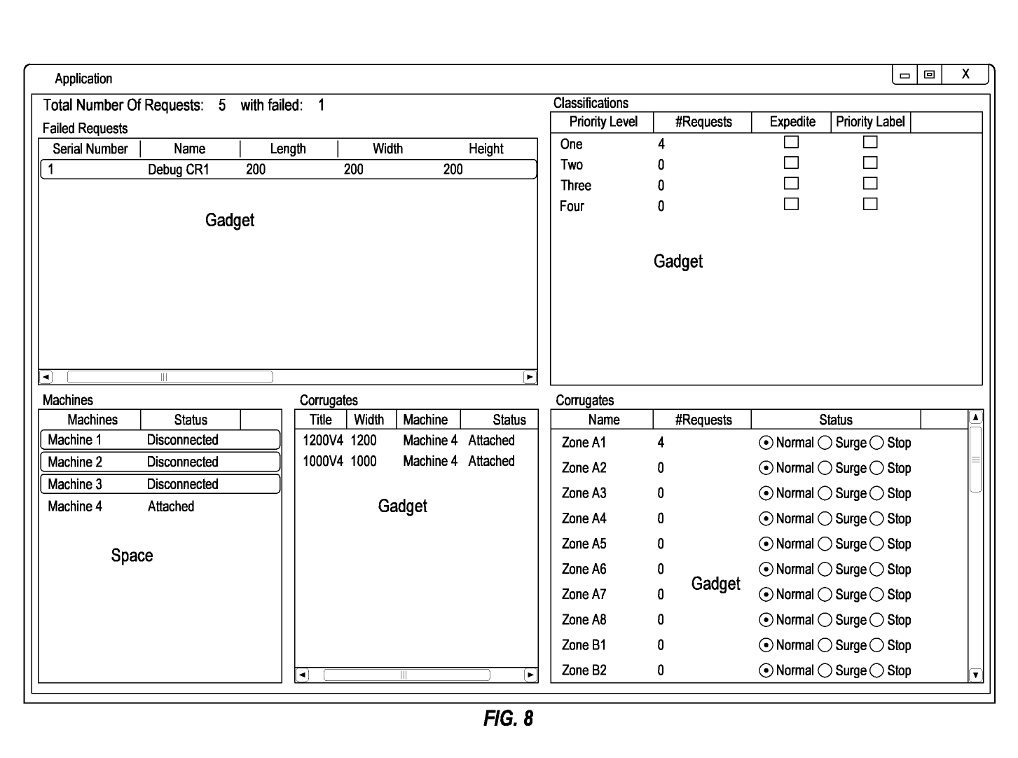

At least in some cases, various different users and user types may use the computer system 101. Each user or user type can have a home view configured that can be reached from any space. In the embodiment illustrated in FIG. 8, the top space (in the hierarchy) is shown for a version of a software application that controls multiple different computer systems. The top space has four predefined gadgets and one user-defined gadget in the space. The gadgets show associated information to the user directly in contrast to the minimized user-defined gadgets which show only a summary of the information available in the space. Expanding a space moves the user down in the hierarchy. Expanding the “Machines” user-defined gadget in the FIG. 8 would lead the user down to the next level of detail, providing more detail about each machine (for example, its operating state, date of last maintenance, last job performed, etc.).

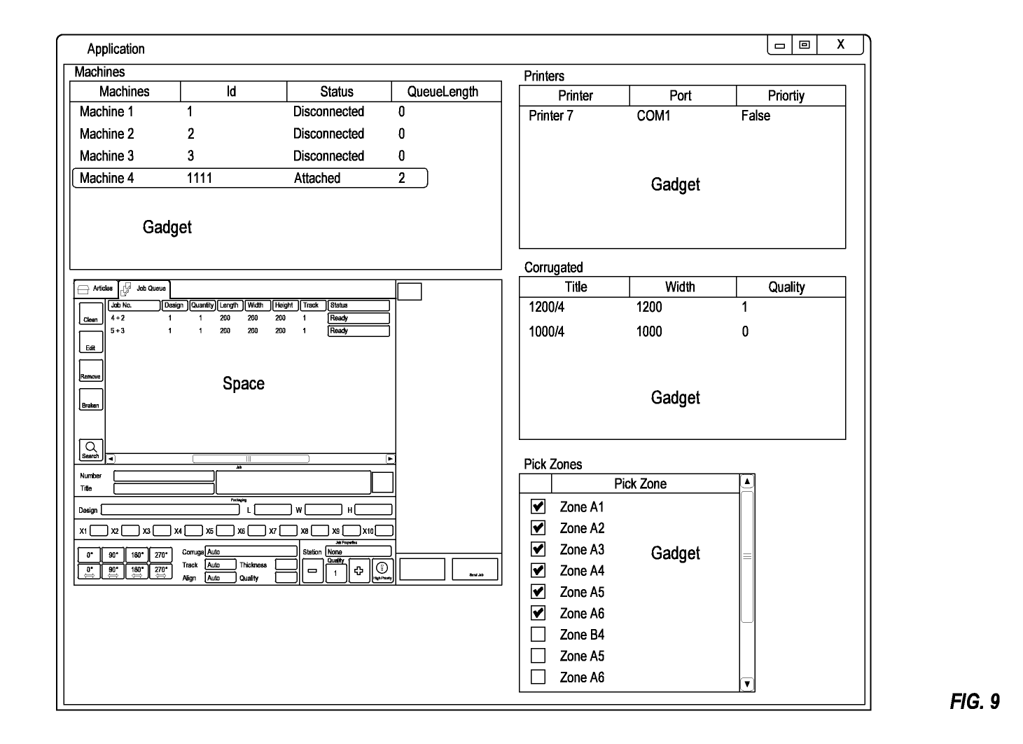

FIG. 9 illustrates the second or “zoomed in” level of the user-defined gadget shown in FIG. 8. Thus, on the second level of FIG. 9, four gadgets and one user-defined gadget are shown. The user-defined gadget and predefined gadgets on the right side are bound to the current machine context. As such, the spaces and gadgets get information from the current machine context in the space. The context can either be configured or selected by a context selection gadget. In this case, the “Machines” gadget itself gets its context from an “all machines” context which has been previously configured). The user-defined gadget at this level is a “production” user-defined gadget. In the first level (as shown in FIG. 8), the user-defined gadget is a minimized view of this space, only showing the “Machines” gadget on the second level, but with a different configuration. At the second level (as shown in FIG. 9), the user-defined gadget is a miniature view of the entire space of the third level.

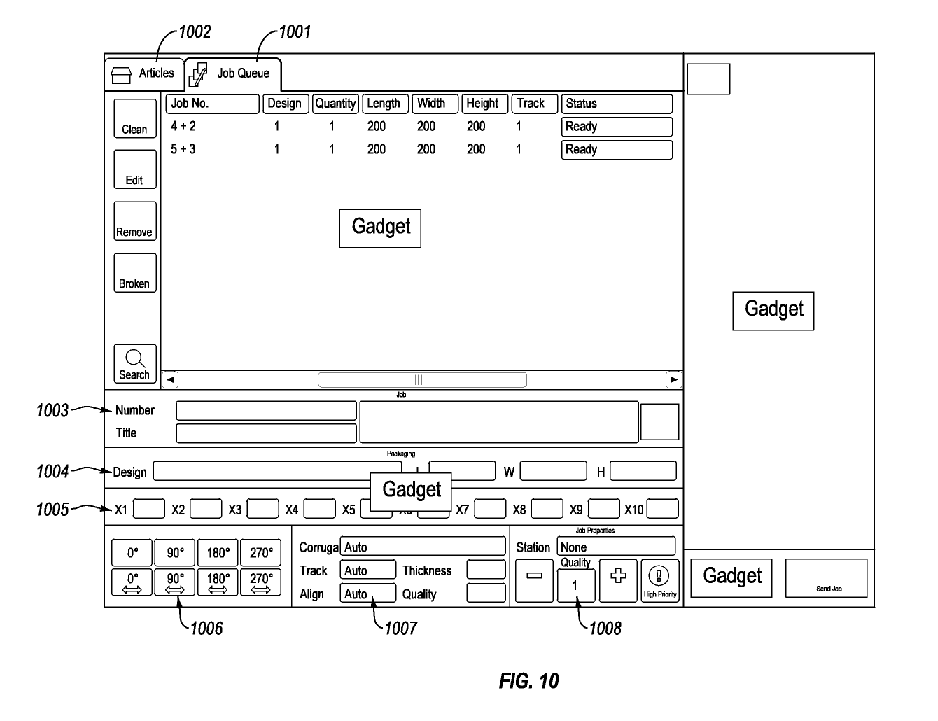

FIG. 10 illustrates a view from a stand-alone machine operator. The main view shown in FIG. 10 is an example home view for a machine operator. This space has five gadgets, while appearing to have four. When two gadgets occupy the same space, a tabbed view is created. This is the case for the Job Queue gadget and the Articles gadget. In this example, both the Job Queue gadget 1001 and the Articles gadget 1002 set the current context for the same type of context (e.g. for a packaging item). When this happens, the last selection will clear the previous selection. This means that selecting an article and then moving to the job queue gadget to select a job will result in the job as the current packaging item and the article will be deselected. The packaging details (bottom left corner) may, in some cases, be built up of several gadgets. The detail gadgets could, for example, be built up of a job information gadget 1003, a packaging gadget 1004, an extra parameter gadget 1005, a rotation permissions gadget 1006, a corrugate gadget 1007 and job properties gadget 1008.

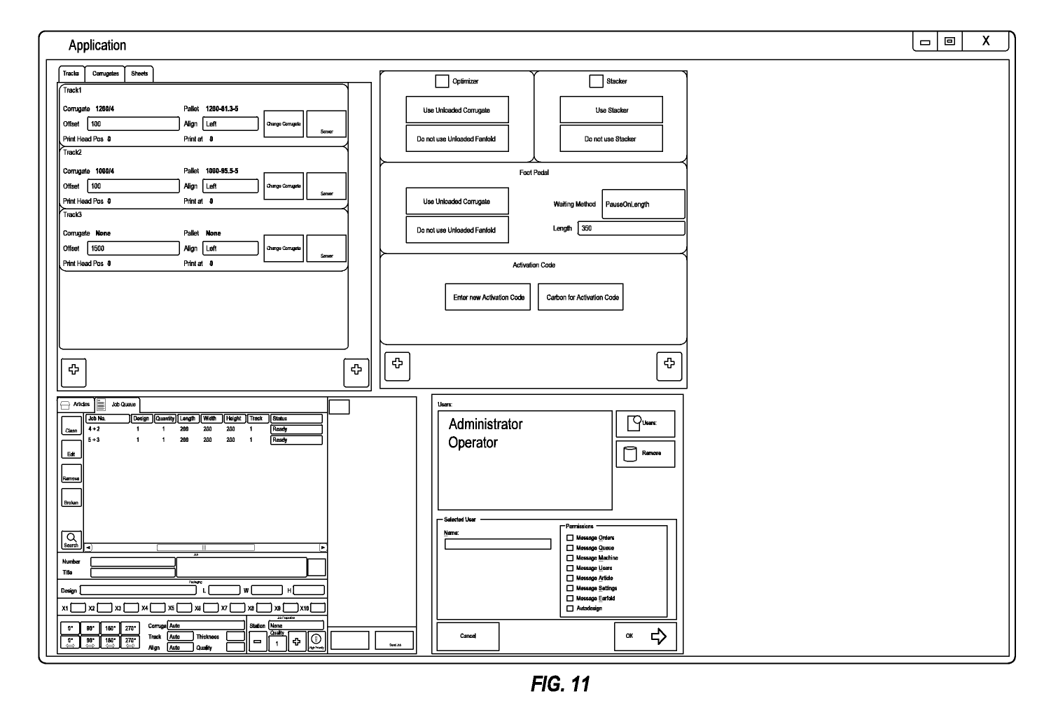

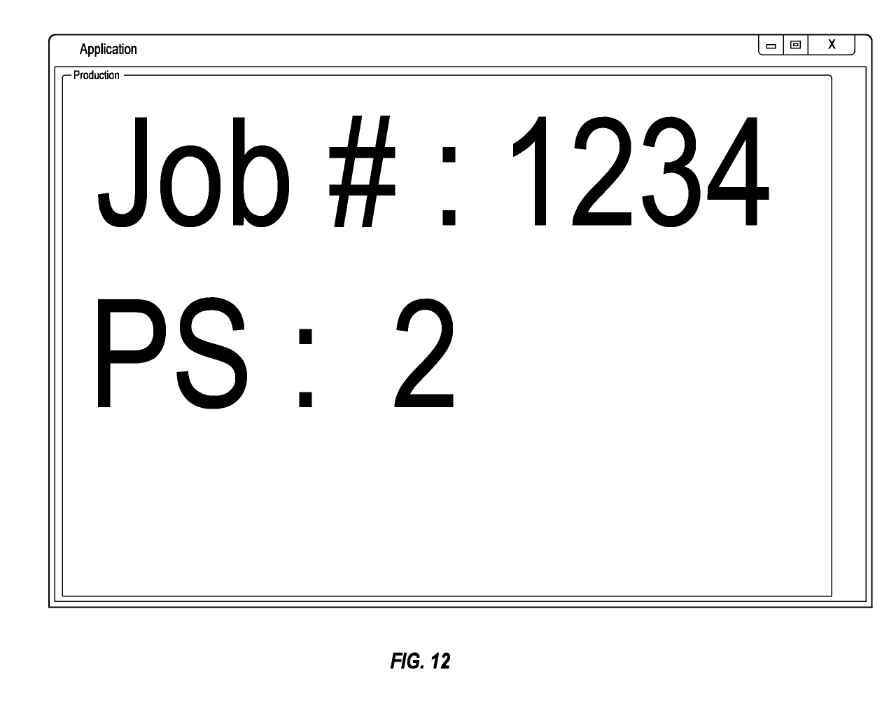

The space shown in FIG. 10 may represent a home view for the user 111. Some users may not be able move from this space (for example, to view more detailed information). However, “super users” might have editing privileges allowing them to move one step above this view while still using the production view as a home space. As such, the top view and home view can be different based on user type. The top space available for the “super users” (as shown in FIG. 11) shows four spaces: corrugate management, settings management, production, and user management. All user-defined gadget in this example are configured to show a miniaturized or scaled-down version of the maximized view. Within any minimized view, user input may be input without having to zoom in.

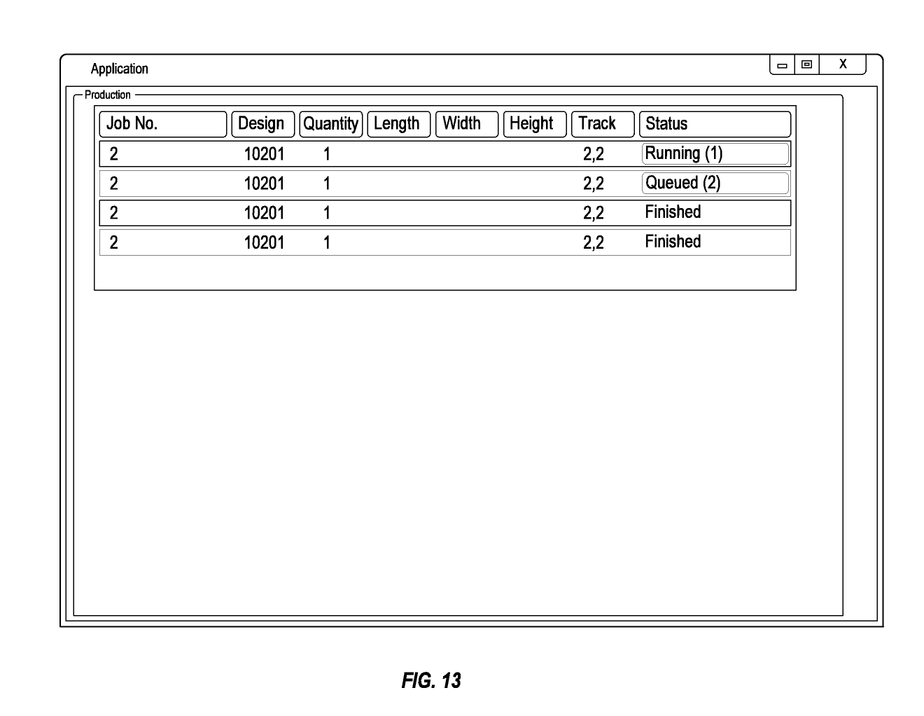

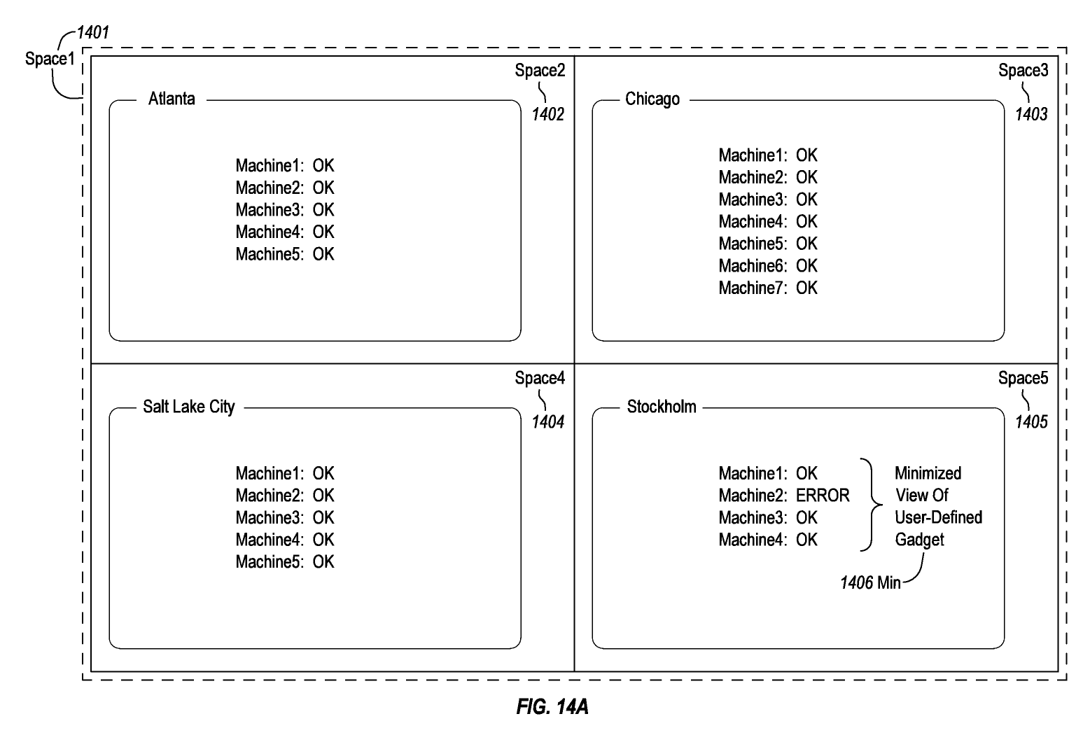

FIG. 12 demonstrates the power of different views of a gadget to create customer specific information in a short amount of time. FIG. 12 illustrates an example home space for user 111. This space only contains one other space, the production space from the previous examples. In FIG. 12, it is shown as a minimized view of the job queue gadget. This view only shows the job number of the last produced job and the designated pack station for that job, allowing the user/operator to clearly see where each box should go. This is an example of a screen that an operator would use in regular production. If something special needs to be done, the operator can simply expand the view allowing the user to get the full production interface with all its options. FIG. 13 illustrates example of the exact same space (shown in FIG. 12) only configured to show another view of the job queue gadget.

It should be noted that while the gadgets, spaces and configuration tools of FIGS. 5-13 are shown as being related to packaging materials, and operating machines that produce packaging materials, the components and features described herein may be applied to any number of different production or other types of scenarios where user interfaces are used, and where user interface customizability may be advantageous. The concepts generally shown by FIGS. 5-13, and by the examples provided above will be described in greater detail below with regard to methods 200, 300 and 400 of FIGS. 2, 3 and 4, respectively.

In view of the systems and architectures described above, methodologies that may be implemented in accordance with the disclosed subject matter will be better appreciated with reference to the flow charts of FIGS. 2, 3 and 4. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 2 illustrates a flowchart of a method 200 for generating a customizable user interface. The method 200 will now be described with frequent reference to the components and data of environment 100.

Method 200 includes an optional act of providing a configuration tool in a user interface (UI), the configuration tool allowing a user to select one or more UI elements including at least one of a gadget and a space, wherein a space comprises an area that holds one or more gadgets, and wherein a gadget comprises a UI control (210). For example, the user interface 102 in FIG. 1 may include configuration tool 103. The configuration tool provides access to UI elements 104 including gadgets 104A and spaces 104B. As mentioned above, spaces include areas within the UI 102 that hold gadgets, which themselves are UI controls. Thus, the configuration tool 103 provides access to UI controls that may be used within spaces in the UI.

Method 200 also includes receiving a first input from the user indicating that a space is to be created within the UI (220). Thus, for example, user 111 may send input 112 indicating that a new space is to be created within UI 102. Upon receiving this input, the computer system 101 may create the space 106 within the UI 102 (230). The space provides context for those gadgets that are added to the space, and the context indicates rules or settings that are to be applied to those gadgets that are added to the space. As shown in FIG. 1, the created space 106 includes or provides context 107 for those gadgets that are added to the space (e.g. added gadgets 108). Thus, any UI control added to a space takes on the context (e.g. settings, characteristics, etc.) of that space. The context, at least in some instances, is only applied if it is of the proper type. For example, as shown in FIG. 9, a machine gadget will only take on the machines context of that space, assuming that the machines context is the only context the gadget uses.

In some cases, the created space 106 may be a minimized space 109. The minimized space may be a space that includes less detail than a full or normal-sized space. The minimized space may, for example, provide a title and basic information, whereas a full-sized space may include additional details. The amount of information shown in the minimized or regular-sized spaces may be customized by the user.

It should also be noted that while the context for gadgets is typically set by the current context of the space in which the gadget is created or used, the context for a space may be set by the gadget's own configuration, or by a context selection gadget. Thus, if a gadget has its own configuration settings, they may overwrite or take precedent over those set by the space in which the gadget is used. Still further, a single space may have multiple contexts of different types simultaneously. The settings or characteristics of these contexts may each have an effect on the behavior of those gadgets created within the space.

Method 200 next includes receiving a second input from the user indicating that at least one gadget is to be added to the created space (240). The input 112 from user 111, for example, may include an indication indicating that a gadget is to be added to space 106. The computer system then adds at least one gadget to the created space, where the one or more context-based rules or settings are applied to the gadgets in the created space (250). The added gadget may include, for example, an article list, an order list, a job list, a packaging preview, or any other type of gadget. The gadgets added to the created space may include gadgets created from stored spaces (also referred to herein as “user-defined gadgets”) created by the user. For example, a developer or other user may create a space and store that space as an user-defined gadget 116. This user-defined gadget may then be used as a gadget, and may be used within other spaces (e.g. space 106).

In some embodiments, when two or more gadgets occupy substantially the same area in the UI 102, a tabbed control may be automatically generated. For instance, if an article, order, job list or other gadget was to occupy the same area of the UI 102, a tabbed control may be automatically generated and shown in the UI, as generally shown in FIG. 6. In some cases, the user 111 may be provided with a selection of one or more views available for each gadget, and may receive an indication from the user, when configuring the created space, indicating which view is to be used with each gadget. In this manner, the user 111 may be able to select which view is to be used with each gadget. In cases where a gadget has multiple different defined views, the user can select which view to use for the gadget. Still further, the UI may show multiple views of the same gadget. For instance, as shown in FIG. 5, the view on the left (501) one may correspond to a default view of a job queue gadget, while the view on the right (502) is the “last completed job”-view of the same gadget. In this manner, each gadget may have multiple different views (including additional views not shown in FIG. 5).

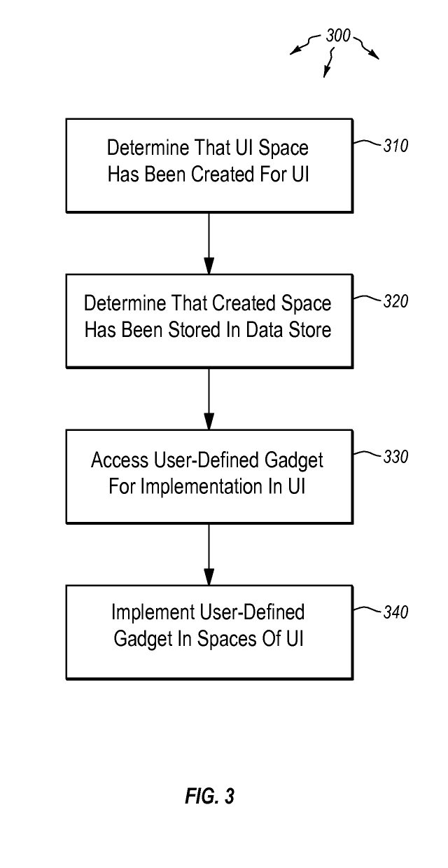

FIG. 3 illustrates a flowchart of a method 300 for implementing predefined gadgets within a user interface. The method 300 will now be described with frequent reference to the components and data of environment 100.

Method 300 includes determining that a space has been created for a user interface (UI), the space providing context for those gadgets and spaces that are added to the space, the context indicating rules or settings that are to be applied to those gadgets that are added to the space (310). The computer system 101 may determine that the created space (e.g. 106) has been stored as a data structure in a data store (e.g. 115) along with at least one predefined gadget or user-defined gadget, where the stored space and gadget together comprise a user-defined gadget 116 (320). The data store 115 may house a plurality of different stored spaces 116. These spaces may be stored at the request of the user 111, or at the request of another entity such as another software program or computer system. The data accessing module 105 may access any of the user-defined gadgets 116 for implementation in the UI 102, where the user-defined gadget itself comprises a user-oriented, foundational gadget for creating customizable user interfaces (330). As mentioned above, the user-defined gadgets are stored spaces which may be used to create other user interfaces or portions of user interfaces. As these user-defined gadgets are defined by the user and are thus oriented to the user, and as the user-defined gadgets are used to create other user interfaces, they are said to be foundational. This term is intended to mean that the user-defined gadgets can be used to form the foundation of user interfaces, and is thus foundational in this sense. Users may mix and match these user-defined gadgets to create their own, personalized user interfaces. In this manner, the user-defined gadgets are both user-oriented and foundational gadgets.

These user-defined gadgets are then implemented in one or more spaces of the UI (340). The accessed spaces then provide a set of functionality as a gadget. Thus, a user or other entity may store a space in a data store and later access that space to provide functionality similar to or the same as a gadget. This allows the user to use user-defined gadgets as building blocks within their UI. At least in some cases, a minimized view of the added space is shown when adding user-defined gadgets to existing spaces. This minimized view may indicate to the user various high-level (or other) aspects of the added space. For instance, the minimized view may be a scaled view of the entire created space. The minimized view, at least in some cases, may include controls provided by the created space. The minimized view of the created space provides the user an overview of the created space, while still allowing direct user interaction. As such, the user may interact with the minimized view, and any changes made through the minimized view will be processed as if they were received through the normal-sized, default view. In this manner, a user may create and use one or many different minimized views for each created space.

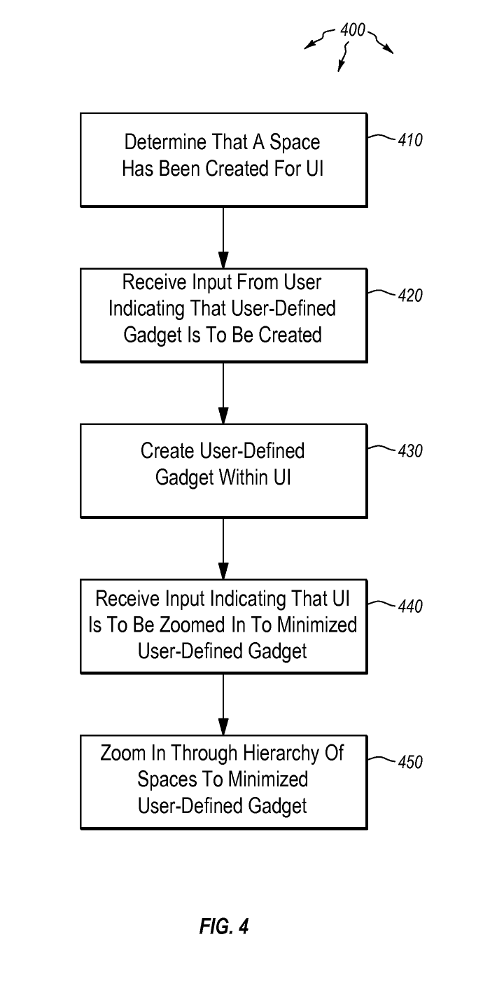

FIG. 4 illustrates a flowchart of a method 400 for providing hierarchical spaces within a user interface. The method 400 will now be described with frequent reference to the components and data of environment 100.

Method 400 includes determining that a space has been created for a user interface (UI), the space providing context for those gadgets that are added to the space (410). Space 106 may be created by computer system 101 within UI 102. The space 106 may be one of many different spaces created within the UI 102. Each space allows many different gadgets to be added (e.g. 108), each gadget receiving context 107 from the space 106. The configuration tool 103 may receive an input from a user 111 indicating that a user-defined gadget is to be created within the UI 102 (420). The computer system 101 may then create the user-defined gadget within the UI, where the user-defined gadget is shown with in a minimized view (430). The space 106 and the user-defined gadget 109 then form a hierarchy 110 in the UI (430). The hierarchy may allow a user to zoom into the user-defined gadget within the hierarchy, so that the space and gadgets that make up the user-defined gadget are shown. For instance, the user may zoom in to go down a level in the hierarchy, or zoom out to go up a level in the hierarchy.

Method 400 next includes receiving an input indicating that the UI is to be zoomed in to the minimized user-defined gadget 109 (440), and further zooms in through the hierarchy 110 of spaces to the minimized user-defined gadget 109 within the UI 102 (450). At least in some cases, a maximized, zoomed in space may provide additional information that was not previously visible, or may hide information that was previously visible. The minimized space can be a summary or scaled-down view of the entire space. The zoomed-in space does not need to provide any additional data. As such, it will be understood that a great deal of customizability exists when implementing minimized views.

In some embodiments, if the minimized user-defined gadget is not configured as a scaled view of the entire space, a subset of the gadgets from a maximized space can be selected as a representation of the minimized user-defined gadget. User-defined gadget and predefined gadgets may each be created with plurality of different views. The user may then select which of the views to use as the minimized view. For example, a gadget for production history may have one minimized view that shows detailed information for the last ten items, and a minimized view that shows serial number of the last item created. When adding a user-defined gadget or predefined gadget to another space, the user 111 can select which of the views to use as minimized view. Once the spaces are set up, the spaces will form a hierarchy, allowing the user to “zoom in” to a minimized user-defined gadget for more detailed information. Still further, it should be noted that minimized user-defined gadgets may be used directly without zooming in, or even without any user inputs. Predefined and user-defined gadgets are viewable in the scaled, zoomed-in view, and, at least in some embodiments, a home view may be presented in the UI 102 that is reachable from all spaces, and allows the user to navigate to default or “home” view. In this manner, minimized views spaces be used in conjunction with other spaces and gadgets to provide a more customized and personalized UI.

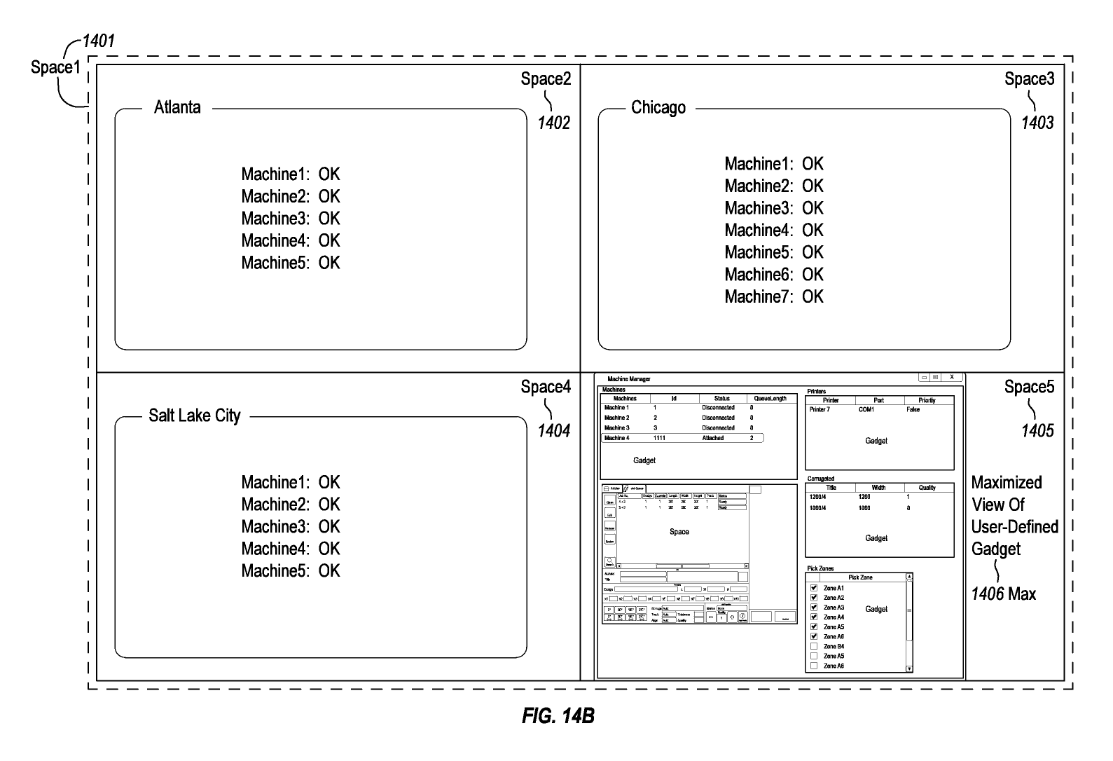

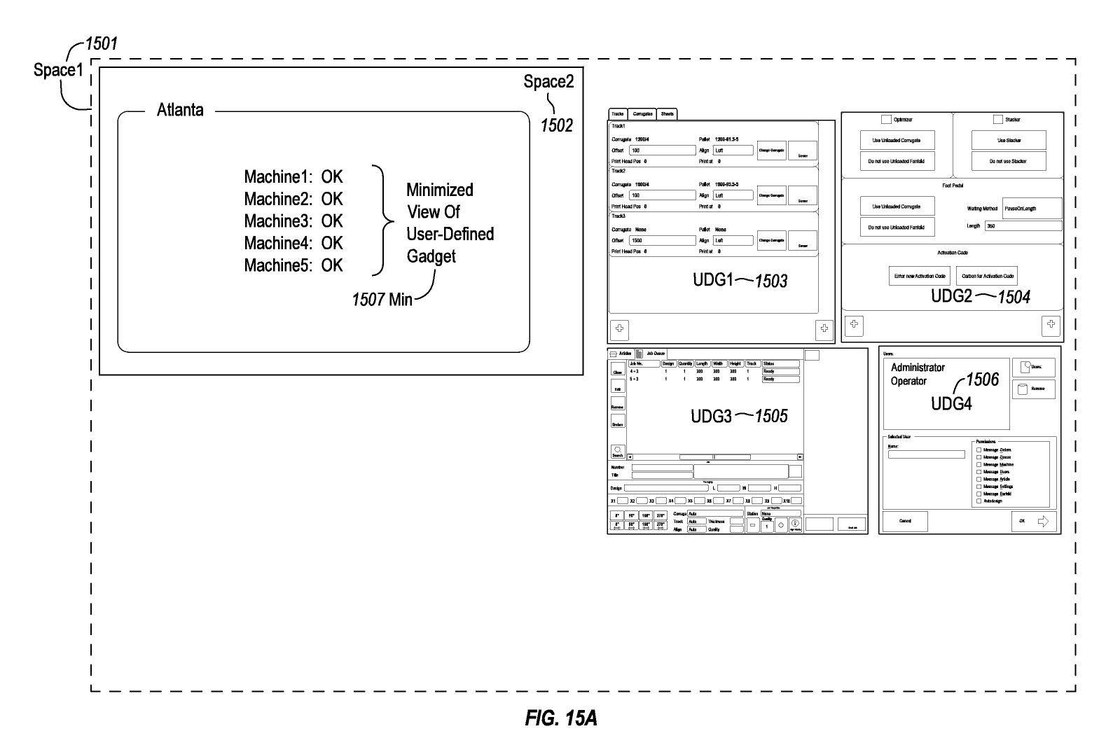

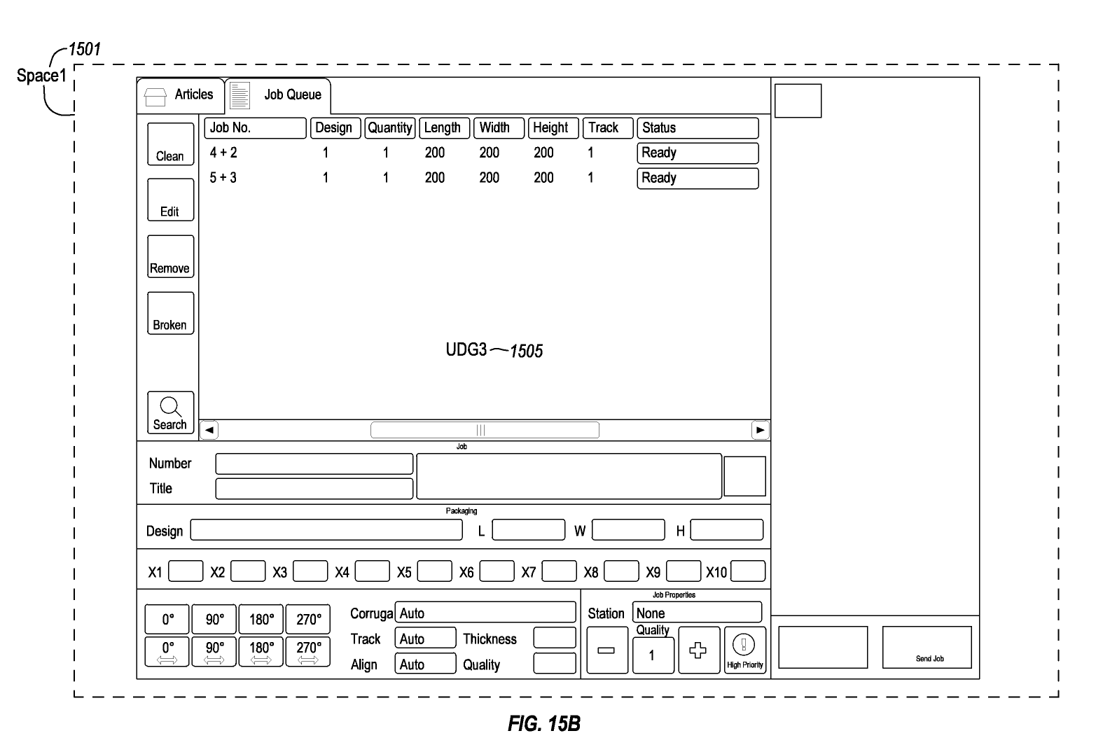

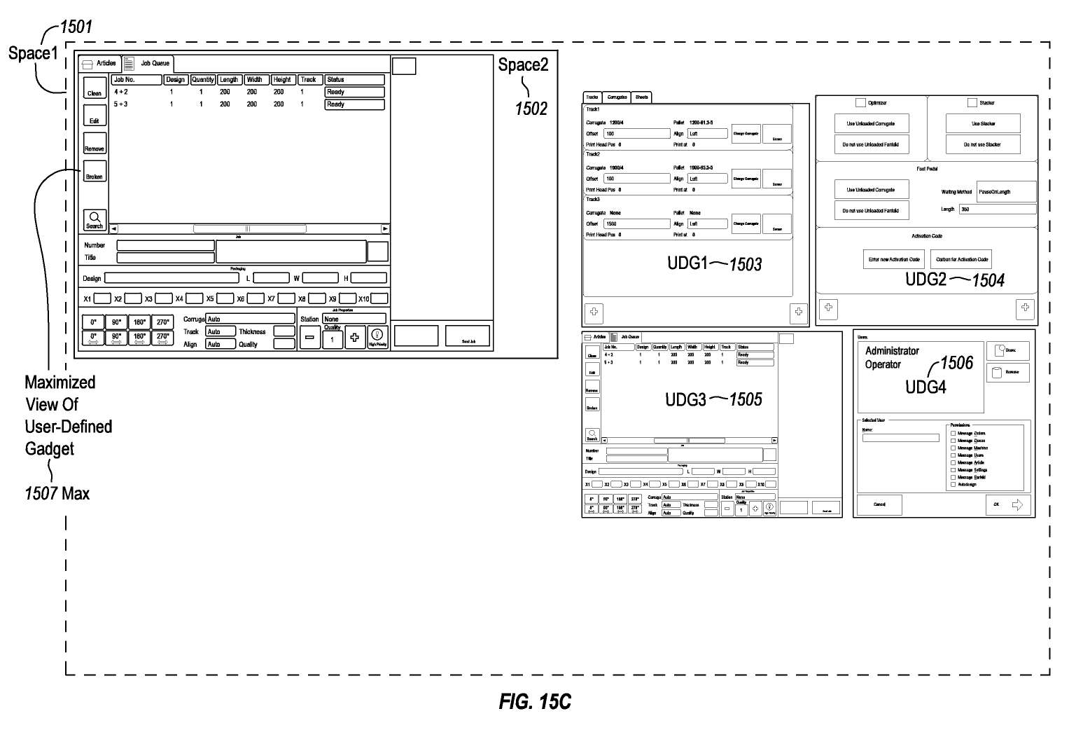

FIGS. 14A, 14B and 15A-15C describe embodiments in which a space (or multiple spaces) is added to an existing space. For example, as shown in FIG. 14A, a first or original space (e.g. space 1 (1401)) may be created in a user interface. The first space may be of any size or shape, and is not limited to being a rectangle as shown in FIG. 14A. In the depicted embodiment, four spaces have been added to space 1: space 2 (1402), space 3 (1403), space 4 (1404) and space 5 (1405). It will be understood that substantially any number of spaces may be added to an existing space and, similarly, that any number of spaces may be added to subsequently added spaces (e.g. a space added to space 5 (1405)). In FIG. 14A, each space includes a user-defined gadget. The view of this user-defined gadget is minimized. As such, a user can view space 1 and see multiple minimized views in different spaces.

If a user wants to view a maximized view of a user-defined gadget (UDG), the user can simply double-click or perform some other gesture that indicates the view is to be maximized. Thus, upon receiving such an input, the minimized view of the UDG 1406min is maximized within its space, as shown in 1406max of FIG. 14B. In the maximized view, details about each of the machines shown in the minimized view are shown. The user can see, for example, various bars, charts or other data related to Machines 1-4 that were shown in the minimized view of the UDG in 1406min.

In FIG. 15A, a first or original space 1501 is shown with dotted lines. Again, the space can have any number of spaces within its boundaries. In this case, space 1 (1501) includes four user-defined gadgets (UDG1 (1503), UDG2 (1504), UDG3 (1505) and UDG4 (1506). These UDGs are shown grouped next to each other. However, it will be understood that the UDGs may be spaced or grouped in substantially any manner, and may be arranged by a user. In some cases, a user may want to maximize or zoom into one of the user-defined gadgets. Thus, for example, in FIG. 15B, UDG3 (1505) may be shown in a maximized state. Because UDG3 (along with UDGs 1, 2 and 4) is part of space 1 (1501), when maximized it fills up the entirety of space 1.

Space 1 (1501) also includes space 2 (1502), which itself has a minimized view of a UDG (1507min). This user-defined gadget may also be maximized, but since it has been created in (or moved to) space 2, it will be maximized within space 2 (1502). Thus, as shown in FIG. 15C, the maximized view of 1507min is shown in space 2 as 1507max. Accordingly, user-defined (or predefined) gadgets may be shown in spaces in their minimized or maximized state. The user may be able to switch between views and between gadgets seamlessly. Moreover, the user may be able to add or remove spaces from spaces, and easily add or remove gadgets to or from those added or original spaces.

In one embodiment, a computer system (e.g. 101 of FIG. 1) may be implemented to perform a method for adding spaces to an existing space. For example, the computer system may determine that a space (e.g. 1401 of FIG. 14A) has been created within a user interface (UI). As explained above, the space provides context for those spaces and gadgets that are added to the space. At least in some embodiments, the context may be configured in the following manner: a computer system may determine that a space has been created for the UI. The computer system may then receive an input from a user indicating that the context of a specific type is configured for the space. The computer system may further receive a second input indicating that a gadget is to be added to the created space, and when the gadget is created, it will receive its context from the created space. The computer system may further determine that various additional spaces (e.g. 1402-1405) are to be added to the created space 1401. These additional spaces may be added and arranged in some fashion. They may be arranged in a rectangular block form, as shown in FIG. 14A, or may be arranged in a circular or other arbitrarily-chosen pattern.

Each additional space may thus be added to the original created space (i.e. 1401). Each additional space may be configured to host user-defined or predefined gadgets. In FIG. 14A, each UDG includes a minimized view of machines (e.g. production machines). The minimized view could show a variety of different data, in a variety of different forms. Similarly, the maximized view could show different data in different forms. Each added space may include one or more UDGs, each shown in a maximized or minimized state. Multiple minimized UDGs may be shown in a single space, while only one maximized view may be shown in a space, as the maximized view will fill the space to which it is assigned (see, for example, UDG3 (1505) of FIG. 15B). In this manner, spaces may be added to spaces, and each added space may have its own selectable set of predefined or user-defined gadgets.

Accordingly, methods, systems and computer program products are provided which generate a customizable user interface. Moreover, methods, systems and computer program products are provided which implement predefined gadgets within a user interface and provide hierarchical spaces within a user interface.

The concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

1. A computer program product for implementing a method for generating a customizable user interface, the computer program product comprising at least one computer-readable storage device having stored thereon computer-executable instructions that, when executed by one or more processors of a computing system, cause the computing system to perform the method, the method comprising:
receiving a first input from a user indicating that a space is to be created within a user interface (UI), each space comprising an area that holds one or more gadgets, each gadget comprising a UI control;
creating a space within the UI, the space providing context for those gadgets that are added to the space, the context indicating one or more rules or settings that are to be applied to those gadgets that are added to the space;
receiving a second input from the user indicating that at least one gadget is to be added to the created space; and
adding at least one gadget to the created space, wherein the one or more context-based rules or settings are applied to the gadgets in the created space.

2. The computer program product of claim 1, wherein the created space includes one or more minimized user-defined gadgets.

3. The computer program product of claim 1, wherein a tabbed control is automatically generated upon determining that two or more gadgets occupy substantially the same area in the UI.

4. The computer program product of claim 1, wherein context for the created space is set by the space's configuration or by a context selection gadget that sets context of a specified type to the space.

5. The computer program product of claim 1, wherein the context for gadgets is set by the current context of the space in which the gadget is used.

6. The computer program product of claim 1, wherein a created space has a plurality of contexts simultaneously.

7. The computer program product of claim 1, further comprising:
providing to the user a selection of one or more views available for each gadget; and
receiving an indication from the user, when configuring the created space, indicating which view is to be used with each gadget.

8. The computer program product of claim 1, wherein at least one of the gadgets has multiple different defined views, such that when configuring the created space, the user can select which view to use for the at least one gadget.

9. The computer program product of claim 1, wherein a plurality of views of the same gadget are presented in the UI.

10. The computer program product of claim 1, wherein list views have a selectable display of columns.

11. The computer program product of claim 1, wherein the gadgets added to the created space comprise user-defined gadgets created using one or more predefined gadgets or user-defined gadgets.

12. The computer program product of claim 1, further comprising providing a configuration tool in the user interface (UI) that allows a user to select one or more UI elements including at least one of a predefined gadget, a user-defined gadget and a space to add to the space that is being configured.

13. A computer system comprising the following:
one or more processors;
system memory;
one or more computer-readable storage media having stored thereon computer-executable instructions that, when executed by the one or more processors, causes the computing system to perform a method for implementing predefined gadgets within a user interface, the method comprising the following:
determining that a space has been created for a user interface (UI), the space providing context for those gadgets and spaces that are added to the space, the context indicating rules or settings that are to be applied to those gadgets that are added to the space;
determining that the created space has been stored as a data structure in a data store along with at least one predefined gadget or user-defined gadget, the stored space and gadget together comprising a user-defined gadget;
accessing the user-defined gadget for implementation in the UI, the user-defined gadget comprising a user-oriented, foundational gadget for creating customizable user interfaces; and
implementing the user-defined gadget in one or more spaces of the UI, the created space providing a set of functionality as a gadget.

14. The computer system of claim 13, further comprising showing a minimized view of the added space when adding user-defined gadgets to existing spaces.

15. The computer system of claim 14, wherein the minimized view is a scaled view of the entire created space.

16. The computer system of claim 14, wherein only controls from inside the created space are available to add to the minimized space.

17. The computer system of claim 14, wherein the minimized view of the created space provides the user an overview of the created space, while still allowing direct user interaction.

18. The computer system of claim 14, wherein the user configures a plurality of minimized views for each created space.

19. A method, implemented at a computer system that includes at least one processor, for providing hierarchical spaces within a user interface, the method comprising:
determining that a space has been created for a user interface (UI), the first space providing context for those gadgets that are added to the first space, the context indicating rules or settings that are to be applied to those gadgets that are added to the space;
receiving an input from a user indicating that a user-defined gadget is to be created within the space;
creating a user-defined gadget within the space, the user-defined gadget comprising a minimized user-defined gadget, the space and the user-defined gadget forming a hierarchy in the UI;
receiving an input indicating that the UI is to be zoomed in to the minimized user-defined gadget; and
zooming in through the hierarchy of user-defined gadgets to the minimized user-defined gadget within the UI.

20. The method of claim 19, wherein a maximized, zoomed-in user-defined gadget provides at least one portion of additional information that was not previously visible.

21. The method of claim 19, wherein if the minimized user-defined gadget is not configured as a scaled view of the entire space, a subset of the gadgets from a maximized space of the user-defined gadget can be selected as a representation of the minimized user-defined gadget.

22. The method of claim 19, wherein user-defined gadgets and gadgets are created with plurality of different views, and wherein the user selects which of the views to use as the minimized view.

23. The method of claim 19, wherein minimized user-defined gadgets are used directly without zooming in.

24. The method of claim 19, wherein predefined and user-defined gadgets are viewable in the scaled, zoomed-in view.

25. The method of claim 19, wherein a single user-defined gadget include a plurality of user-defined gadgets.

26. The method of claim 19, wherein the user interface has a home view that is reachable from all spaces.

27. A computer system comprising the following:
one or more processors;
system memory;
one or more computer-readable storage media having stored thereon computer-executable instructions that, when executed by the one or more processors, causes the computing system to perform a method for adding spaces to existing spaces, the method comprising the following:
determining that a space has been created within a user interface (UI), the space providing context for those spaces and gadgets that are added to the space, the context indicating rules or settings that are to be applied to those gadgets that are added to the space;
determining that one or more additional spaces are to be added to the created space; and
adding the one or more additional spaces to the created space, each additional space being configured to host one or more user-defined gadgets or predefined gadgets;
wherein those user-defined and predefined gadgets that are added to the created space are displayable in a minimized view with one or more other user-defined or predefined gadgets in a maximized view where the hosted user-defined or predefined gadget fills the additional space to which the hosted user-defined or predefined gadget is assigned.

28. The computer system of claim 27, wherein user-defined gadgets and gadgets are created with plurality of different views, and wherein the user selects which of the views to use in the minimized view and which of the views to use in the maximized view.
